(19) United States
(12) Patent Application Publication
(10) Pub. No.: US 2020/0295835 A1
(43) Pub. Date: Sep. 17, 2020

(54) LOCAL AREA NETWORK

(71) Applicant: BRITISH TELECOMMUNICATIONS PUBLIC LIMITED COMPANY, London (GB)

(72) Inventor: Ian COOPER, London (GB)

(21) Appl. No.: 15/733,148

(22) PCT Filed: Nov. 27, 2018
(86) PCT No.: PCT/EP2018/082713

§ 371 Date: May 28, 2020

(30) Foreign Application Priority Data
Nov. 28, 2017 (EP) 17204105.5

(51) Int. Cl. H04B 10/40; H04B 10/27; H04B 10/2575

(52) U.S. Cl. CPC H04B 10/40; H04B 10/25754; H04B 10/27

(57) ABSTRACT

The disclosure provides a local area network transceiver including a plurality of G.fast transceivers and a vectoring engine. The transceiver can be used to replace an existing Fast Ethernet or Gigabit Ethernet transceiver in order to increase the data transmission capacity of a link in the local area network.

### PRIORITY CLAIM

The present application is a National Phase entry of PCT Application No. PCT/EP2018/082713, filed Nov. 27, 2018, which claims priority from EP Patent Application No. 17204105.5, filed Nov. 28, 2017, each of which is hereby fully incorporated herein by reference.

### TECHNICAL FIELD

The present disclosure relates to a local area network and in particular a transceiver for use in a local area network.

### BACKGROUND

Ethernet has been widely used to provide wired local area networks (LANs). Gigabit Ethernet (GigE) technologies allow Ethernet frames to be transmitted at a rate of 1 gigabit per second (Gb/s). More specifically, IEEE 802.3ab defines Gigabit Ethernet transmission using conventional unshielded twisted pair cabling enabling LAN users to upgrade from Fast Ethernet, which transmits at 100 Mb/s, to Gigabit Ethernet without needing to install new cabling.

FIG. 1 shows a schematic depiction of a conventional wired local area network 100 in which a first router 150 is connected to first and second terminals 130A, 130B via respective LAN connections 140A, 140B. Similarly, a second router 170 is connected to first and second terminals 190A, 190B via respective LAN connections 180A, 180B. A direct connection between the first router 150 and the second router 170 is provided by a communications link 160. It will be readily understood that a typical LAN will comprise multiple routers and/or multiple terminals connected to each router and that FIG. 1 shows only two routers with only two terminals connected to each router for the sake of clarity and ease of understanding.

As is well understood, if it is required to transmit data from terminal 130B to terminal 130A then data packets will be transmitted over LAN connection 140B to the first router 150. The first router 150 will then route these packets to terminal 130A via LAN connection 140A. Similarly, if it is required to transmit data from terminal 130A to terminal 190B then data packets will be transmitted from terminal 130A to the first router 150. The first router will then route the packets to the second router 170 via the communications link 160. The second router will then route the packets to the terminal 190B via the LAN connection 180B.

Typically the data rate provided over the communications link 160 is greater than that provided over the LAN connections 140, 180. For example, the communications link 160 may use Gigabit Ethernet technology whilst the LAN connections may use Fast Ethernet technology. It will be understood that if the communications link 160 may become overloaded if there is significant traffic being transmitted from the terminals connected to the first router (i.e. terminals 130A, 130B) to the terminals connected to the second router (i.e. terminals 190A, 190B).

FIG. 2 shows a more detailed schematic depiction of the first and routers 150, 170 of the conventional wired local area network described above with reference to FIG. 1. First router 150 comprises a plurality of ports 1502, switch fabric 1504 and transceiver 1506. The transceiver 1506 is connected to the communications link 160. Similarly, the second router 170 comprises a plurality of ports 1702, switch fabric 1704 and transceiver 1706. The transceiver 1706 is connected to the other end of the communications link such that it can communicate with transceiver 1506 of the first router.

Each of the plurality of input ports 1502 are arranged to receive a LAN connection 140 (not shown) which connects the router to a terminal 130 (not shown). A packet received at a port is forwarded to the switch fabric 1504 which inspects the packet for a network address and routes the packet accordingly. If the network address held within the packet is the address of another terminal 130 connected to the first switch then the packet will be routed to the appropriate port such that the packet can be transmitted to that terminal 130.

If the network address is that of a terminal 190 connected to the second router then the packet will be routed to transceiver 1506. The transceiver will transmit the packet over the communications link 160 to the transceiver 1706 of the second router, which will then forward the packet to the switch fabric 1704 of the second router 170. The packet will then be routed to the terminal 190 connected to the second router which is associated with the network address stored in the header of the packet. It will be understood that the process of routing a packet from a terminal 190 connected to the second router to a terminal 130 connected to the first router is the reverse of the process described above.

The first and second transceivers 1506, 1706 may comprise Fast Ethernet transceivers if the 100 Mb/s data capacity is sufficient for the communications link 160. As the demands for data transmission between the first and second nodes increase then the first and second transceivers 1506, 1706 may be upgraded from Fast Ethernet transceivers to Gigabit Ethernet transceivers without needing to change the cabling from category 5 twisted pair cabling. If there is a further increase in traffic leading to the communications link 160 becoming overloaded then a conventional approach would be to provide a second Gigabit Ethernet between the first and second routers and to use the link aggregation protocol described in IEEE 802.3ad. However, such a solution requires that both of the first and second routers have an available port and a further category 5 cable must be provided.

### SUMMARY

According to a first aspect of the disclosure , there is provided a transceiver for use in a local area network, the transceiver comprising a plurality of G.fast transceivers and a vectoring engine. The transceiver may comprise four G.fast transceivers.

The transceiver may be a small form-factor pluggable (SFP) transceiver. In use, one of more of the plurality of fast transceivers may be activated or deactivated.

According to a second aspect of the disclosure, there is provided a local area network component comprising a transceiver as described above. The local area network component may be a router or a terminal.

### BRIEF DESCRIPTION OF THE FIGURES

In order that the present disclosure may be better understood, embodiments thereof will now be described, by way of example only, with reference to the accompanying drawings in which:

FIG. 1 shows a schematic depiction of a conventional wired local area network.

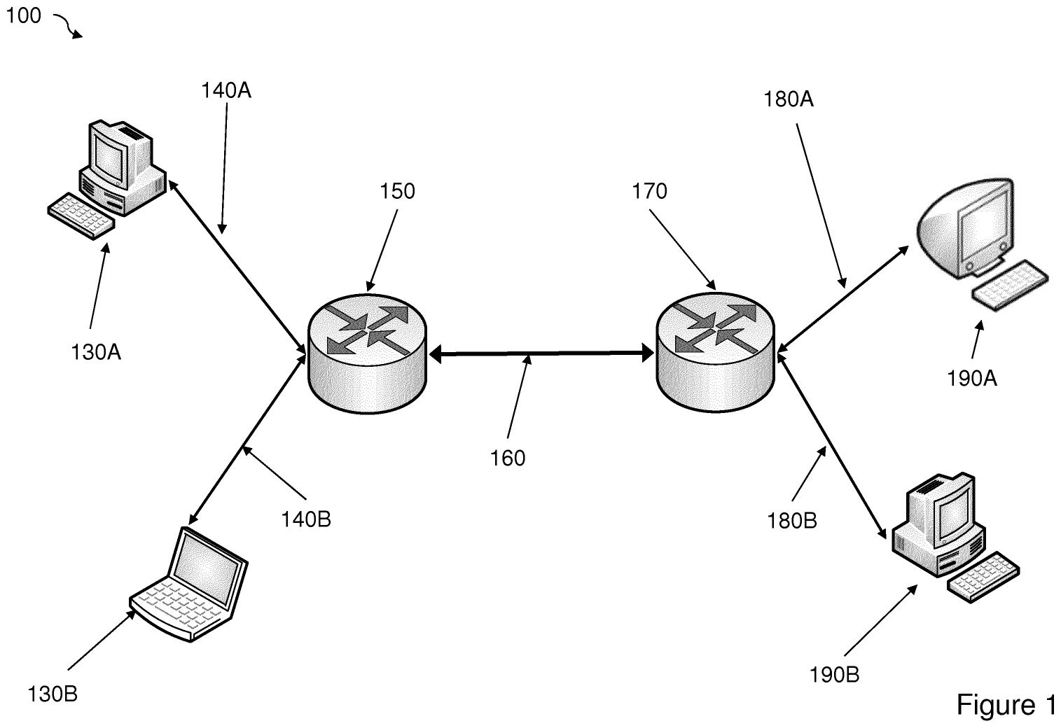

FIG. 2 shows a more detailed schematic depiction of the first and routers of the wired LAN of FIG. 1.

FIG. 3 is a schematic depiction of the first and second routers 150 170 comprising transceivers according to an aspect of the present disclosure.

### DETAILED DESCRIPTION OF EMBODIMENTS

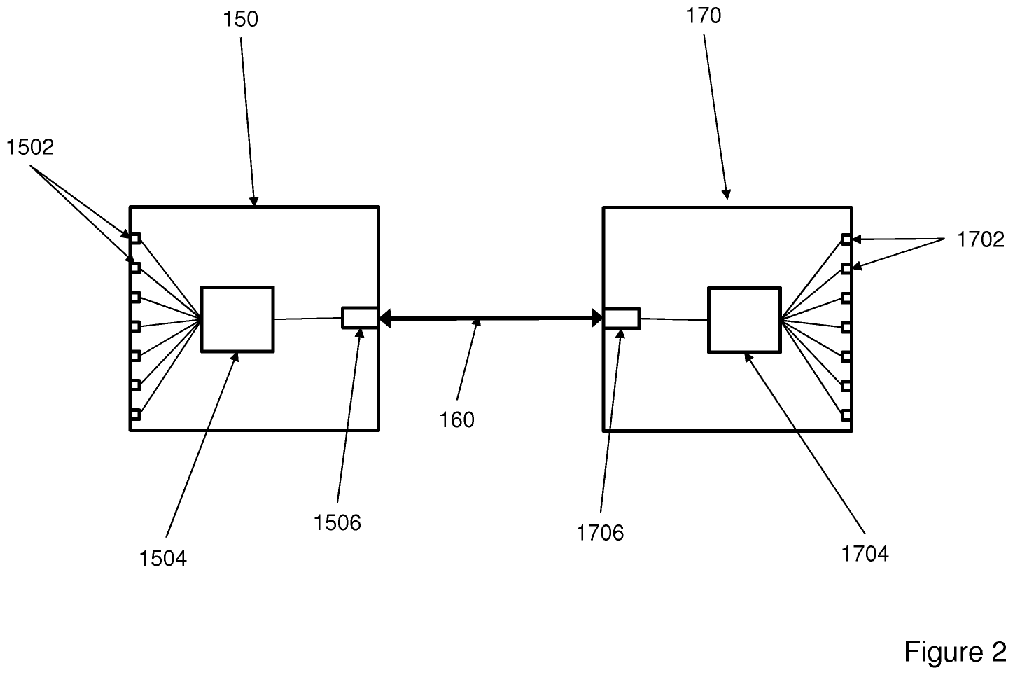

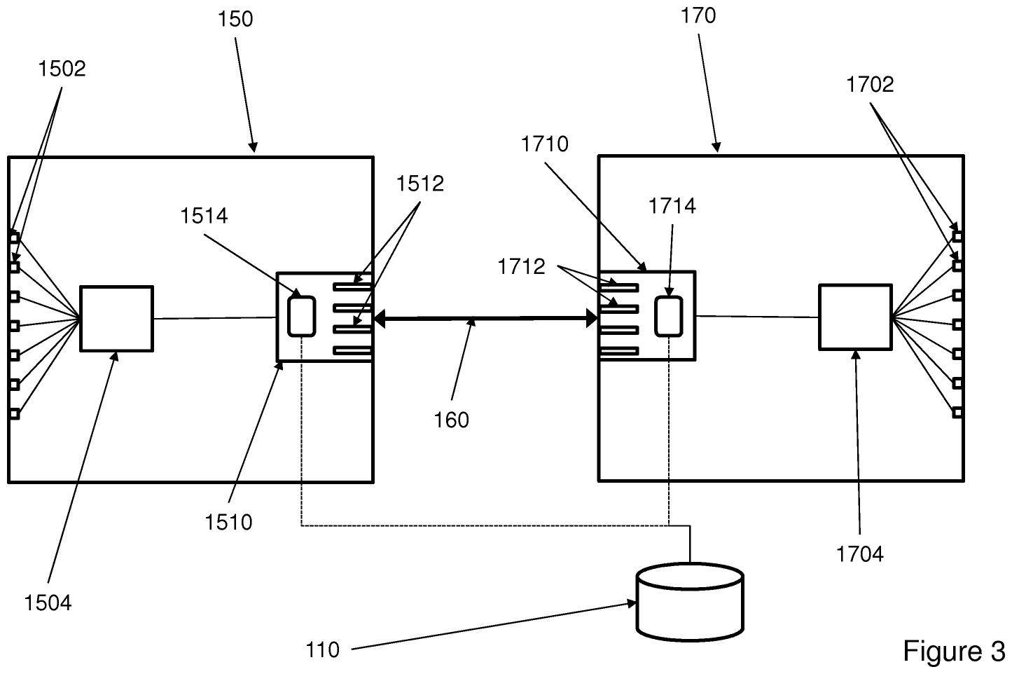

FIG. 3 is a schematic depiction of the first and second routers 150, 170 described above with reference to FIG. 2 with the exception that the first and second routers comprise first and second transceivers 1510, 1710 according to an aspect of the present disclosure respectively. The process by which packets are routed between terminals is the same as that described above with reference to FIG. 2 and will not be repeated here. The first transceiver 1510 comprises four G.fast transceivers 1512 and a vectoring engine 1514. Similarly, the second transceiver 1710 comprises four G.fast transceivers 1712 and a vectoring engine 1714.

G.fast is an access network data transmission technology which is used in hybrid fiber-copper access network architectures such as Fiber to the Cabinet (FTTCab) and Fiber to the Node (FTTN) networks. VDSL (Very-high-bit-rate digital subscriber line) technology is conventionally used in such networks to provide downstream data rates of up to 80 Mbit/s (depending on the length of the copper cable connecting the customer premises to the VDSL DSLAM). G.fast is beginning to be deployed as it can provide data rates of 500 Mbit/s over cable lengths of 100 m, with data rates decreasing as the cable length increases further.

The transceiver 1510 comprises four G.fast transceivers 1512 which are coupled to the communications link 160 such that each of the G.fast transceivers is connected to one of the twisted pairs in the category 5 cable. The category 5 twisted pair cable conventionally used in LANs for Fast Ethernet and Gigabit Ethernet comprises four pairs of twisted wires, similar to those used in the metallic cables used in FTTCab & FTTN networks. Network segments for Fast Ethernet and Gigabit Ethernet are limited to a length of 100 m so by using four G.fast transceivers it is possible to achieve a total data rate of 2000 Mbit/s over the existing communications link.

The transceiver 1510 further comprises a vectoring engine 1514 which processes the signals transmitted by the G.fast transceivers in order to reduce crosstalk within the communications link and to reduce any interference between a signal sent on a first twisted pair in the cable and a further twisted pair in that cable. It will be understood that the second transceiver 1710 operates in the same manner as described above such that G.fast signals are transmitted and received bi-directionally within the communications link 160 between the first and second router.

Existing Gigabit Ethernet first and second transceivers 1506, 1706 can be replaced with first and second transceivers according to the present invention 1510, 1710 to improve the capacity of the existing communications link from 1 Gb/s to 2 Gb/s over a cable length of up to 100 meters without needing to change the installed cabling. Whilst conventional Ethernet standards allow for data rates in excess of 1 Gb/s these require installation of new cabling (optical fiber for higher category twisted pair cables). The transceivers according to the present disclosure may be small form-factor pluggable (SFP) transceivers such that they are physically compatible with the routers (and other network elements into which they may be installed).

It will be understood that a transceiver according to the present disclosure could be used in other scenarios within a local area network. For example, in addition to being used to provide a link between two nodes (as described above) a transceiver according to the present invention could be installed in a terminal with a further terminal being installed at the port of the router to which the terminal is connected.

It should be understood that the number of individual G.fast transceivers active within a transceiver may be controlled by software. Activating two of the G.fast transceivers will provide the same data capacity as Gigabit Ethernet, i.e. 1 Gb/s, with the activation of a third transceiver increasing the capacity to 1.5 Gb/s and the activation of the fourth transceiver increasing the capacity to 2 Gb/s. The transceiver may have an interface which can be accessed by conventional network management software or systems such that one or more of the G.fast transceivers can be activated or deactivated as needed. For flexibility of operation it may be preferred to install a transceiver according to the present invention even where the current capacity requirement could be met by a conventional Gigabit Ethernet if it is predicted that the data capacity requirement is likely to increase significantly. As the data capacity needed rises above 1 Gb/s then a third G.fast transceiver can be activated and as the data capacity needed rises above 1.5 Gb/s then the fourth G.fast transceiver can be activated. As the vectoring engines 1514, 1714 control the operation of the respective G.fast transceivers 1512, 1712, the vectoring engine may have an interface to a network operational support system 110.

Signals sent from the network operational support system 110 can be used to control the number of G.fast transceivers which are active and thus determine the data transmission capacity of the transmission link 160. It will be understood that the interface to the network operational support system 110 may alternatively be to the transceivers 1510, 1710 or to the individual G.fast transceivers 1512, 1712 rather than to the vectoring engine.

In one aspect, the present disclosure provides a local area network transceiver comprising a plurality of G.fast transceivers and a vectoring engine. The transceiver can be used to replace an existing Fast Ethernet or Gigabit Ethernet transceiver in order to increase the data transmission capacity of a link in the local area network.

1. A transceiver for use in a local area network, the transceiver comprising:
a plurality of G.fast transceivers and
a vectoring engine.

2. The transceiver according to claim 1, the transceiver being arranged to be connectable, via a communications link, with a transceiver of another network component in the local area network, wherein each of the plurality of G.fast transceivers is arranged to be connectable, via the communications link, to a respective G.fast transceiver of the transceiver of the other network component.

3. The transceiver according to claim 1, wherein the transceiver comprises four G.fast transceivers.

4. The transceiver according to claim 1, wherein the transceiver is a small form-factor pluggable (SFP) transceiver.

5. The transceiver according to claim 1, wherein, in use, one or more of the plurality of G.fast transceivers can be activated or deactivated.

6. The transceiver according to claim 5, wherein, in use, the transceiver receives a signal to determine which of the plurality of G.fast transceivers are activated.

7. The transceiver according to claim 6, wherein, in use, the signal is received by the vectoring engine.

8. The transceiver according to claim 6, wherein, in use, the signal is received from an operational support system.

9. The transceiver according to claim 5, wherein the activation or deactivation of one or more of the plurality of G.fast transceivers is to respectively increase or decrease a data capacity of the one or more of the plurality of G.fast transceivers over the communications link.

10. A local area network component comprising the transceiver according to claim 1.

11. The local area network component according to claim 10, wherein the local area network component is a router or a terminal.
